(19) United States
(12) Patent Application Publication
(10) Pub. No.: US 2026/0199973 A1
(43) Pub. Date: Jul. 16, 2026

(54) A TUBE FURNACE FOR THE USE IN A SINTERING AND/OR DEBINDING PROCESS

(71) Applicant: BASF SE, Ludwigshafen am Rhein (DE)

(72) Inventors: Tobias ROEDLMEIER, Heidelberg (DE); Grigorios KOLIOS, Ludwigshafen am Rhein (DE)

(21) Appl. No.: 19/135,414

(22) PCT Filed: Nov. 30, 2023
(86) PCT No.: PCT/EP2023/083814

§ 371 Date: Jun. 4, 2025

(30) Foreign Application Priority Data
Dec. 5, 2022 (EP) 22211501.6

(51) Int. Cl. B22F 3/10; B22F 10/62; B22F 10/64; B33Y 40/20; C04B 35/10; C04B 35/185; C04B 35/80; F27D 1/10

(52) U.S. Cl. CPC B22F 3/1025; B22F 10/62; B22F 10/64; B33Y 40/20; C04B 35/10; C04B 35/185; C04B 35/80; F27D 1/10; B22F 2998/10; C04B 2235/3217; C04B 2235/3463; C04B 2235/5264; C04B 2235/9669

(57) ABSTRACT

The present invention relates to the use of a tube furnace in a sintering and/or debinding process, wherein the tube furnace comprises a tube (T) comprising an oxide ceramic matrix composite (OCMC). In addition, the present invention relates to a tube furnace for the use in a sintering and/or debinding process, wherein the tube furnace comprises a tube (T) comprising an oxide ceramic matrix composite (OCMC). Moreover, the present invention relates to the use of the inventive tube furnace in a process for the treatment of at least one three-dimensional green body (GB).

The present invention relates to the use of a tube furnace in a sintering and/or debinding process, wherein the tube furnace comprises a tube (T) comprising an oxide ceramic matrix composite (OCMC). In addition, the present invention relates to a tube furnace for the use in a sintering and/or debinding process, wherein the tube furnace comprises a tube (T) comprising an oxide ceramic matrix composite (OCMC). Moreover, the present invention relates to the use of the inventive tube furnace in a process for the treatment of at least one three-dimensional green body (GB).

A task often encountered in recent times is the production of prototypes, spare parts, and models of metallic or ceramic bodies, particularly, of prototypes, spare parts and models exhibiting complex geometries. Specially to produce prototypes, a rapid production process is necessary. For this so called “rapid prototyping”, different processes are known. One of the most economical is the fused filament fabrication process (FFF), also known as “fused deposition modelling” (FDM).

The fused filament fabrication process (FFF) is an additive manufacturing technology. A three-dimensional object is produced by extruding a thermoplastic material through a nozzle to form layers as the thermoplastic material hardens after extrusion. The nozzle is heated to heat the thermoplastic material past its melting and/or glass transition temperature and is then deposited by the extrusion head on a base to form the three-dimensional object in a layer-wise fashion. The thermoplastic material is typically selected, and its temperature is controlled so that it solidifies substantially immediately upon extrusion or dispensing onto the base with the build-up of multiple layers to form the desired three-dimensional object.

To form each layer, drive motors are provided to move the base and/or the extrusion nozzle (dispending head) relative to each other in a predetermined pattern along the x-, y- and z-axis. The FFF-process was first described in U.S. Pat. No. 5,121,329.

Typical materials to produce three-dimensional objects are thermoplastic materials. The production of three-dimensional metallic or ceramic objects by fused filament fabrication is only possible if the metal or ceramic material has a low melting point so that it can be heated and melted by the nozzle. If the metal or ceramic material has a high melting point, it is necessary to provide the metal or ceramic material in a binder composition to the extrusion nozzle. The binder composition usually comprises a thermoplastic material. When depositing the mixture of a metal or ceramic material in a binder on a base, the formed three-dimensional object is a so called “green body”, which comprises the metal or ceramic material in a binder. To receive the desired metallic or ceramic object, the binder must be removed and finally the object must be sintered. The three-dimensional object which is formed after removing the binder is a so-called “brown body”; the three-dimensional object which is formed after sintering is a so-called “sintered body”. The removing of the binder is also called “debinding”.

Usually, the sintering and/or the debinding processes are carried out in a furnace.

There are different types of furnaces for different kinds of applications. One type of furnace is the so-called tube furnace. It includes a tube-like structure with heating elements outside this tube. The tube can be closed on both ends, open on both ends or closed on one end and open on the other end. With a gas-tight tube and connectors to the tube a controlled atmosphere inside the tube can be generated. Different kinds of gases with controlled pressures can be used for heating processes, like a sintering and/or debinding process of three-dimensional printed or metal injection molded parts.

There are different types of materials available to build such a tube, wherein it is important that the tube withstands the process conditions without any damage which can be caused, for example, by thermal stress or mechanical stress. For sintering and/or debinding processes of three-dimensional printed or metal injection molded parts, it is additionally desired that the tube is capable of operating at temperatures >1250° C., while the inner diameter of the tube is larger than 90 mm and the heated length of the tube is larger than 300 mm. By the term “heated length” in the context of the present invention the effective heated length is meant which means, the section in which the temperature in the tube deviates from the target temperature setpoint by −10K to +10K. This section is, therefore, the section in which a homogeneous temperature is achieved.

Nevertheless, although by using materials based on metals or metal alloys as tube material, large inner diameters up to 245 mm are possible without the introduction of critical thermal stress, higher temperatures, or a negative pressure (vacuum) at higher temperatures, lead to the deformation of the tube. Furthermore, the debinding process is often carried out with an acid, especially a gaseous acid, which leads to the corrosion of the tubes, for example, of tubes made of titanium or titanium alloys. On the other hand, by using materials based on ceramics or glasslike materials, higher temperatures than 1250° C. are achievable but inner diameters larger than 90 mm introduce critical thermal stress and damage the tube.

As of now, none of the known tube materials can fulfill all desired criteria, namely, to be non-corrosive in oxidizing and reducing atmosphere, in acidic and alkaline media, chemically inert, creep resistant and fatigue resistant at temperatures >1250° C. while having an inner diameter of larger than 90 mm and a heated length of larger than 300 mm.

The international patent application WO 2016/184776 A1 describes a gas-tight multilayer composite tube which has a heat transfer coefficient of >500 W/m²/K and contains at least two layers, one layer made of a nonporous monolithic oxide ceramic and one layer made of an oxide fibre composite ceramic.

The European patent application EP 3 835 639 A1 describes a gas-tight multilayer composite tube with a heat transfer coefficient of >500 W/m²/K comprising at least two layers, which in its construction over the cross-section of the wall of the composite tube has as an inner layer a non-openly porous monolithic oxide ceramic which is enclosed by an outer layer of oxide fibre composite ceramic and where an electrically conductive system is embedded in the wall of the composite tube.

The international patent application WO 2019/201654 A1 describes a device for the sealed connection of two tubular elements (10, 20), wherein an end face of a first tubular element is connected in a sealed manner to an end face of a second tubular element. Each tubular element has a collar (12, 22) extending radially outwards, wherein the second tubular element (20) is made of a ceramic material, its connection-side end is at least partially provided with a circumferential support layer, a sleeve made of a ceramic material surrounds the support layer as a collar (22) and is firmly connected thereto, and the connection element (30) is connected to the outside of the sleeve. The support layer is made of an oxide ceramic fibre composite material.

The international patent application WO 2020/187607 A1 describes a gas-tight multilayer composite tube with a heat transfer coefficient of >500 W/m²/K, which in its structure has, as an inner layer over the cross section of the wall of the composite tube, a non-porous monolithic oxide ceramic, which is enclosed by an outer layer of oxidic fibre-composite ceramic, this outer layer having an open porosity of 5%<ε<50%, and which has on the inner surface of the composite tube multiple depressions directed towards the outer wall of the composite tube.

The disadvantage of the state of the art is that the oxidic ceramic composite reinforcement is only permanently resistant up to approximately 1200° C. In addition, the oxidic ceramic composite loses its beneficial mechanical properties such as strength and quasi-ductility. Consequently, in this temperature range, the oxidic ceramic composite is becoming brittle and sensitive to thermal shocks.

The object underlying the present invention is, therefore, to provide an improved tube furnace which can be used in a sintering and/or debinding process and which does not have the above-mentioned disadvantages of the prior art or only to a significantly reduced extent.

This object is solved by the use of a tube furnace in a sintering and/or debinding process, wherein the tube furnace comprises a tube (T) comprising an oxide ceramic matrix composite (OCMC).

Another object of the present invention is a tube furnace for the use in a sintering and/or debinding process, wherein the tube furnace comprises a tube (T) comprising an oxide ceramic matrix composite (OCMC).

A further object of the present invention is the use of an inventive tube furnace in a process for the treatment of at least one three-dimensional green body (GB), wherein the process comprises at least the following steps
a) providing the at least one three-dimensional green body (GB), wherein the at least one three-dimensional green body (GB) comprises an inorganic powder (IP) and a binder (B),
b) providing an acid,
c) treating the at least one three-dimensional green body (GB) with the acid in the tube furnace in order to obtain at least one three-dimensional brown body (BB), and optionally
d) sintering the at least one three-dimensional brown body (BB) obtained in step c) in the tube furnace in order to obtain at least one three-dimensional sintered body (SB).

It has surprisingly been found that by the use of a tube furnace in a sintering and/or debinding process, wherein the tube furnace comprises a tube (T) comprising an oxide ceramic matrix composite (OCMC), inner diameters of the tube in the range from 50 mm to 500 mm, more preferably in the range from 90 mm to 400 mm, especially preferably in the range from 90 mm to 300 mm and most preferably in the range from 120 mm to 280 mm are possible and the tube (T) can be heated so as to achieve a homogeneous temperature over a length of at least 100 mm, preferably over a length of at least 300 mm, at temperatures in the range from 1250° C. to 1500° C. without damage and/or corrosion of the tube, while the end zones of the tube outside the furnace are cold.

Moreover, it has surprisingly been found that the inventive tube furnace can also be used in a process for the treatment of at least one three-dimensional green body (GB), in which the at least one three-dimensional green body (GB) is treated with an acid, especially a gaseous acid, without corrosion of the tube furnace occurs. A process in which a three-dimensional green body (GB) is treated with a gaseous acid is also called a catalytic debinding process.

It is even possible that a debinding process, especially a catalytic debinding process, and a sintering process take place subsequently or in parallel without any kind of equipment change or interaction. This leads to a very fast and robust workflow.

The invention is specified in more detail as follows.

### Tube Furnace

The first object of the present invention is the use of a tube furnace in a sintering and/or debinding process, wherein the tube furnace comprises a tube (T).

### Tube (T)

In a preferred embodiment, the tube (T) comprises an inner tube (IT) and an outer layer (OL), wherein the outer layer (OL) is attached to the inner tube (IT) and wherein the inner tube (IT) comprises a non-porous monolithic oxide ceramic and the outer layer (OL) comprises the oxide ceramic matrix composite (OCMC).

Preferably, the inner tube (IT) comprises a wall (W) with an inner surface (IS) and an outer surface (OS), wherein the outer layer (OL) is preferably attached to the outer surface (OS) of the wall (W) of the inner tube (IT). It is possible that the outer layer (OL) covers the outer surface (OS) of the wall (W) of the inner tube (IT) either over the entire length of the inner tube (IT) or over sections of the inner tube (IT) axis.

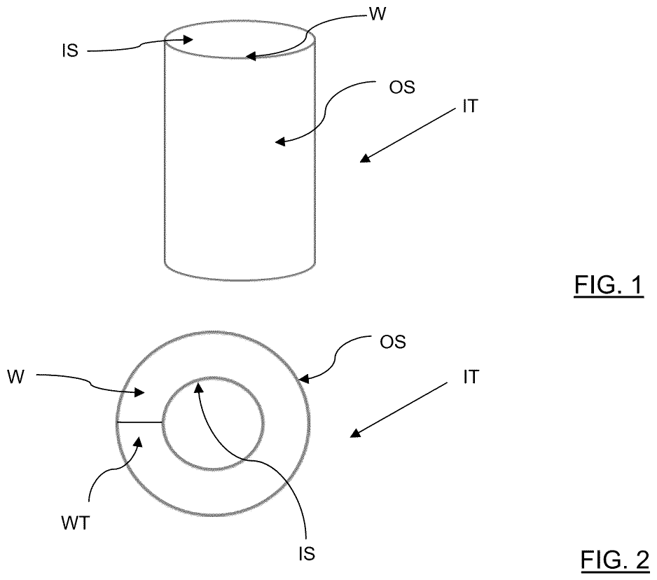

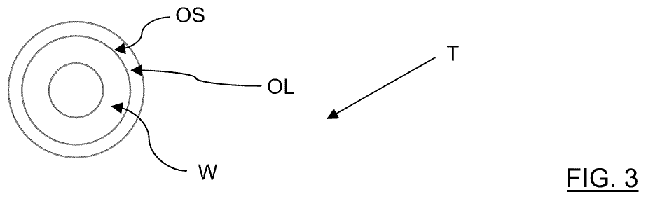

FIG. 1 shows the inner tube (IT) comprising a wall (W) with an inner surface (IS) and an outer surface (OS). FIG. 3 shows the cross-section of a tube (T) comprising an inner tube (IT) and an outer layer (OL), wherein the outer layer (OL) is attached to the outer surface (OS) of the wall (W) of the inner tube (IT).

In case, the outer layer (OL) covers the outer surface (OS) of the wall (W) of the inner tube (IT) partially, i.e., over sections of the inner tube (IT) axis, there are the advantages that the costs of the tube (T) are lower and that the heat transfer in the central, hot area of the tube (T) is improved.

The wall (W) of the inner tube (IT) usually has a wall thickness (WT). The inner tube (IT) can have any desired wall thickness (WT). Preferably, the wall thickness (WT) of the inner tube (IT) is in the range from 0.5 to 45 mm, more preferably in the range from 1 to 25 mm, and most preferably in the range from 3 to 15 mm.

FIG. 2 shows the cross-section of an inner tube (IT) comprising a wall (W) with an inner surface (IS) and an outer surface (OS) and a wall thickness (WT).

The outer layer (OL) can also have any desired thickness. Preferably, the outer layer (OL) has a thickness in the range from 0.5 to 5 mm, more preferably a thickness in the range from 0.5 to 4 mm.

The total thickness of the wall thickness (WT) of the inner tube (IT) and the thickness of the outer layer (OL) can also have any desired range. Preferably, the total thickness of the wall thickness (WT) of the inner tube (IT) and the thickness of the outer layer (OL) is in the range from 1 to 50 mm, more preferably in the range from 1.5 to 29 mm, and most preferably in the range from 3.5 to 19 mm.

Preferably, the tube furnace comprises heating elements outside the tube (T). The tube furnace can comprise any desired heating elements. Preferably, the tube furnace comprises a metallic heating element.

The tube (T) preferably comprises two ends, wherein the tube (T) is closed on both ends, open on both ends or closed on one end and open on the other end.

The inner diameter of the inner tube (IT) can have any desired range. Preferably, the inner diameter of the inner tube (IT) is in the range from 50 mm to 500 mm, more preferably in the range from 90 mm to 400 mm, especially preferably in the range from 90 mm to 300 mm and most preferably in the range from 120 mm to 280 mm.

In a preferred embodiment, the tube (T) is heated over a length from 100 mm to 1000 mm, preferably from 300 mm to 600 mm.

As defined above, by the term “heated length” in the context of the present invention the effective heated length is meant which means, the section of the tube (T) in which the temperature in the tube (T) deviates from the target temperature setpoint by −10K to +10K. This section is, therefore, the section in which a homogeneous temperature is achieved.

The tube (T) can be heated to any desired temperature. Preferably, the tube (T) is heated to a temperature in the range from 15° C. to 1500° C., more preferably to a temperature in the range from 100° C. to 1500° C., and most preferably to a temperature in the range from 1250° C. to 1500° C.

The tube (T) preferably comprises an inner tube (IT) and an outer layer (OL).

### Inner Tube (I7)

The inner tube (IT) comprises a non-porous monolithic oxide ceramic. Preferably, the inner tube (IT) consists of a non-porous monolithic oxide ceramic.

### Non-Porous Monolithic Oxide Ceramic

As non-porous monolithic oxide ceramic, any non-porous monolithic oxide ceramic known to a person skilled in the art can be used.

In the context of the present invention, the term “non-porous” means that the porosity of the oxide ceramic is preferably <10%, more preferably <4%. The porosity is defined as (the ratio of the void volume of the oxide ceramic to the total volume of the oxide ceramic) *100%.

In the context of the present invention, the term “monolithic” means that the inner tube (IT) which comprises the non-porous oxide ceramic is preferably prepared as one continuous piece from the non-porous oxide ceramic. The production processes of monolithic ceramics are known in the art, for example, described in Informationszentrum Technische Keramik, IZTK (Hrsg). (1999). Brevier Technische Keramik.

The non-porous monolithic oxide ceramic preferably comprises at least 90% by weight, more preferably at least 95% by weight and most preferably at least 97% by weight, of at least one compound selected from the group consisting of aluminum oxide (Al₂O₃) and mullite (Al₄₊₂ₓSi₂₋₂ₓO₁₀₋ₓx≈0,4), based on the total weight of the non-porous monolithic oxide ceramic. As non-porous monolithic oxide ceramic, it is possible to use, in particular, Haldenwanger Pythagoras 1800Z™, Pythagoras 1800 (mullite), Alsint 99.7™, Kyocera Degussit® AL23 or Degussit® AL24 (aluminum oxide).

However, it is also possible that the non-porous monolithic oxide ceramic is at least one compound selected from the group consisting of ZrO₂, Y₂O₃ and MgO. Moreover, it is also possible that the non-porous monolithic oxide ceramic comprises considerable amounts of non-oxidic compounds, such as carbides or nitrides, for example SiC, Si₃N₄, AlN.

The density of the non-porous monolithic oxide ceramic is preferably greater than the density of the oxide ceramic matrix composite (OCMC). The density of the non-porous monolithic oxide ceramic is preferably in the range from 1 000 to 7 000 kg/m³, more preferably in the range from 2 000 to 5 000 kg/m³, for example 2 800 kg/m³ for mullite or 3 700 kg/m³ for aluminum oxide (Al₂O₃) with a purity of >99.7%.

### Outer Layer (OL)

The outer layer (OL) comprises the oxide ceramic matrix composite (OCMC). Preferably, the outer layer (OL) consists of the oxide ceramic matrix composite (OCMC).

### Oxide Ceramic Matrix Composite (OCMC)

The oxide ceramic matrix composite (OCMC) preferably comprises
a matrix (M), wherein the matrix (M) comprises oxidic ceramic particles (P), and
fibres (F),
   wherein the fibres (F) are embedded as a linear, sheet-like, or three-dimensional textile structure between the oxidic ceramic particles (P) of the matrix (M).

The oxidic ceramic particles (P) are usually present in sintered form, which means that they are present as a solid block.

In a more preferred embodiment, the oxide ceramic matrix composite (OCMC) consists of
a matrix (M), wherein the matrix (M) comprises oxidic ceramic particles (P), and
fibres (F),
   wherein the fibres (F) are embedded as a linear, sheet-like, or three-dimensional textile structure between the oxidic ceramic particles (P) of the matrix (M).

The density of the oxide ceramic matrix composite (OCMC) is preferably in the range from 500 to 3 000 kg/m³.

### Matrix (M)

The matrix (M) comprises oxidic ceramic particles (P), preferably the matrix (M) consists of oxidic ceramic particles (P).

The oxidic ceramic particles (P) can comprise in principle any desired ceramic oxides. The oxidic ceramic particles (P) are preferably particles comprising oxides of at least one element selected from the group comprising Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te, or mixtures of these oxides.

In the context of the present invention the term “oxides of at least one element” means that the oxides can either comprise precisely one element from the group comprising Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te or that the oxides can comprise two or more elements from the group comprising Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te. An example of an oxide, which comprises two or more elements from the group comprising Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te, is A1₂SiO₅.

The oxidic ceramic particles (P) are more preferably particles comprising oxides of at least one element selected from the group comprising Ti, Zr, Hf, Cr, Fe, Al, Si, Na, K, most preferably particles comprising oxides of at least one element selected from the group comprising Zr, Al, Si.

In an especially preferred embodiment, the oxidic ceramic particles (P) are particles comprising oxides of at least one element selected from the group comprising Zr, Al, Si.

In a most preferred embodiment, the oxidic ceramic particles (P) comprise a mixture of aluminum oxide and silicon oxide, preferably the oxidic ceramic particles (P) consist of a mixture of aluminum oxide and silicon oxide.

### Fibres (F)

The oxide ceramic matrix composite (OCMC) preferably comprises fibres (F).

As fibres (F), in principle all known fibres can be used. Preferably, the fibres (F) are ceramic fibres (F), more preferably nonoxidic and/or oxidic ceramic fibres (F), most preferably oxidic ceramic fibres (F).

The oxidic ceramic fibres (F) preferably comprise an oxide of at least one element selected from the group comprising Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te, or mixtures of these oxides.

In a more preferred embodiment, the oxidic ceramic fibres (F) comprise a compound selected from the group consisting of alumina, for example NEXTEL 610 or OxCeFi A99, mullite, a mixture of alumina and mullite, for example NEXTEL 720 or OxCeFi M75, zirconia toughened alumina (ZTA) and zirconia toughened mullite (ZTM), more preferably, the oxidic ceramic fibres (F) consist of a compound selected from the group consisting of alumina, mullite, a mixture of alumina and mullite, zirconia toughened alumina (ZTA) and zirconia toughened mullite (ZTM).

The nonoxidic fibres (F) preferably comprise at least one compound selected from the group consisting of boron nitride, tungsten carbide, aluminum nitride, barium titanate, lead zirconate titanate and boron carbide.

Of course it is also possible that the fibres (F) comprise an oxide of at least one element selected from the group comprising Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te, or mixtures of these oxides, and/or at least one compound selected from the group consisting of boron nitride, tungsten carbide, aluminum nitride, barium titanate, lead zirconate titanate and boron carbide. In this case, the fibres (F) have a nonoxidic ceramic portion and an oxidic ceramic portion.

The fibres (F) can have any desired diameter. The fibres (F) preferably have a diameter in the range from 5 to 15 μm, more preferably in the range from 10 to 12 μm.

The fibres (F) are embedded as a linear, sheet-like, or three-dimensional textile structure between the oxidic ceramic particles (P) of the matrix (M), preferably they are embedded as a sheet-like or three-dimensional textile structure between the oxidic ceramic particles (P) of the matrix (M).

An example for a linear textile structure is a fibre bundle, into which many fibres (F) are combined. Such fibre bundles can be wound on a bobbin (roving).

Examples for sheet-like textile structures are woven fabrics, knitted fabrics, braids or nonwovens which are processed from fibres (F), for example, from linear textile structures like fibre bundles.

An example for a three-dimensional textile structure (body structure) is a textile hose which are also processed from fibres (F), for example, from linear textile structures like fibre bundles.

Suitable rovings are NEXTEL 610 1500denier, NEXTEL 610 4500denier, NEXTEL 610 10000denier, NEXTEL 610 20000denier, NEXTEL 720 1500denier and 10000denier. Suitable sheet-like or three-dimensional textile structures are NEXTEL 610 DF11, DF-13-4500, DF19, NEXTEL 720 EF11 and EF19.

The fibres (F) can comprise
i) the same components as the oxidic ceramic particles (P), or
ii) different components than the oxidic ceramic particles (P).

The tube (T) is preferably prepared by a process comprising at least the following steps i) and ii)
i) providing the inner tube (IT) comprising the non-porous monolithic oxide ceramic, and
ii) attaching the outer layer (OL) to the inner tube (IT), preferably by a laminating technique.

Preferably, step i) comprises at least the following steps
i-1) preparation of particles of the non-porous monolithic oxide ceramic,
i-2) preparation of a three-dimensional green body from the particles prepared in step i-1), for example, by moulding, extrusion or isostatic pressing, preferably by extrusion or isostatic pressing,
i-3) sintering of the three-dimensional green body obtained in step i-2) in order to obtain the inner tube (IT).

The attachment of the outer layer (OL) to the inner tube (IT) according to step ii) is preferably carried out by a laminating technique comprising the following steps
ii-1) providing the fibres (F), wherein the fibres (F) are in the form of a linear, sheet-like, or three-dimensional textile structure, preferably in the form of a sheet-like, or three-dimensional textile structure,
ii-2) infiltrating the fibres (F) with a slurry, wherein the slurry comprises water, oxidic ceramic particles (P) and a binder (B1), to obtain infiltrated fibres (IF),
ii-3) laminating the inner tube (IT) with the infiltrated fibres (IF) obtained in step ii-2) to obtain a laminated inner tube (LIT),
ii-4) drying the laminated inner tube (LIT) obtained in step ii-3) at a temperature in the range of 40 to 150° C., preferably at a temperature in the range of 60 to 100° C., to remove at least a part of the water and to obtain a dried laminated inner tube (DLIT), and
ii-5) sintering the dried laminated inner tube (DLIT) obtained in step ii-4) at a temperature in the range of 1100 to 1300° C., preferably at a temperature in the range of 1150 to 1250° C., to remove the binder (B1) and the water completely and to obtain the tube (T), wherein the tube (T) comprises an inner tube (IT) and an outer layer (OL), wherein the outer layer (OL) is attached to the inner tube (IT) and wherein the inner tube (IT) comprises a non-porous monolithic oxide ceramic and the outer layer (OL) comprises the oxide ceramic matrix composite (OCMC).

Steps ii-1) to ii-5) can be repeated until the desired thickness of the outer layer (OL) is achieved.

The binder (B1) is preferably at least one compound selected from the group consisting of ZrO₂, Al₂O₃ and SiO₂.

The infiltration in step ii-2) is preferably carried out by dipping or knife coating, preferably by knife coating.

Another object of the present invention is also a tube furnace for the use in a sintering and/or debinding process, wherein the tube furnace comprises a tube (T) comprising an oxide ceramic matrix composite (OCMC).

For the tube furnace, the above-mentioned embodiments and preferences in respect of the use of the at least one tube furnace in a sintering and/or debinding process apply analogously.

The tube furnace is used in a sintering and/or debinding process, preferably in a debinding process of at least one three-dimensional green body (GB) in order to obtain at least one three-dimensional brown body (BB) and/or in a sintering process of at least one three-dimensional brown body (BB) in order to obtain at least one three-dimensional sintered body (SB).

### Use of the Tube Furnace in a Process for the Treatment of at Least One Three-Dimensional Green Body (GB)

Another object of the present invention is, therefore, the use of the inventive tube furnace in a process for the treatment of at least one three-dimensional green body (GB), wherein the process comprises at least the following steps
a) providing the at least one three-dimensional green body (GB), wherein the at least one three-dimensional green body (GB) comprises an inorganic powder (IP) and a binder (B),
b) providing an acid,
c) treating the at least one three-dimensional green body (GB) with the acid in the tube furnace in order to obtain at least one three-dimensional brown body (BB), and optionally
d) sintering the at least one three-dimensional brown body (BB) obtained in step c) in the tube furnace in order to obtain at least one three-dimensional sintered body (SB).

The process for the treatment of the at least one three-dimensional green body (GB) according to the present invention comprises at least steps a) to c) and optionally step d).

Steps a) and b) can be carried out at the same time, but it is also possible that step a) is carried out before step b) or that step b) is carried out before step a). Step c) is preferably carried out after steps a) and b) and optional step d) is preferably carried out after step c), more preferably directly after step c).

### Step a)

In step a), at least one three-dimensional green body (GB) is provided.

The term “at least one three-dimensional green body” according to the present invention means precisely one three-dimensional green body and mixtures of two or more three-dimensional green bodies.

The at least one three-dimensional green body (GB) comprises an inorganic powder (IP) and a binder (B), wherein the binder (B) preferably comprises

(b1) at least one polyoxymethylene (POM).

Preferably, the at least one three-dimensional green body (GB) comprises from 30 to 70% by volume of the inorganic powder (IP) and from 30 to 70% by volume of the binder (B), based on the total volume of the at least one three-dimensional green body (GB), where the % by volume of the inorganic powder (IP) and the binder (B) generally add up to 100%.

More preferably, the at least one three-dimensional green body (GB) comprises from 45 to 65% by volume of the inorganic powder (IP) and from 35 to 55% by volume of the binder (B), based on the total volume of the at least one three-dimensional green body (GB), where the % by volume of the inorganic powder (IP) and the binder (B) generally add up to 100%.

Particularly preferably, the at least one three-dimensional green body (GB) comprises from 48 to 60% by volume of the inorganic powder (IP) and from 40 to 52% by volume of the binder (B), based on the total volume of the at least one three-dimensional green body (GB), where the % by volume of the inorganic powder (IP) and the binder (B) generally add up to 100%.

In one embodiment of the present invention, the at least one three-dimensional green body (GB) comprises at least one dispersant. Preferably, the at least one three-dimensional green body (GB) comprises from 0.1 to 5% by volume of the at least one dispersant, particularly preferably from 0.2 to 4% by volume of the at least one dispersant and most preferably from 0.5 to 2% by volume of the at least one dispersant, based on the total volume of the at least one three-dimensional green body (GB).

To the person skilled in the art, it is clear, that, if the at least one three-dimensional green body (GB) comprises at least one dispersant, the % by volume of the inorganic powder (IP), the binder (B) and the at least one dispersant generally add up to 100%.

“At least one dispersant” according to the present invention means precisely one dispersant and, also, mixtures of two or more dispersants.

Examples for suitable dispersants are oligomeric polyethylene oxide having a low molecular weight of from 200 to 600 g/mol, stearic acid, stearamides, hydroxystearic acids, fatty alcohols, fatty acid esters, sulfonates and block copolymers of ethylene oxide and propylene oxide and also, particularly preferably, polyisobutylene.

The components of the at least one three-dimensional green body (GB) are presented in more detail below.

### Inorganic Powder (IP)

The at least one three-dimensional green body (GB) comprises an inorganic powder (IP).

As inorganic powder (IP), any known inorganic powder (IP) can be used. Preferably, a sinterable inorganic powder (IP) is used. More preferably, the inorganic powder (IP) is a powder of at least one inorganic material selected from the group consisting of a metal, a metal alloy and a ceramic material, most preferably the inorganic powder (IP) is a metal or a metal alloy, particularly preferably, the inorganic powder (IP) is a metal.

“An inorganic powder (IP)” means precisely one inorganic powder (IP) as well as a mixture of two or more inorganic powders (IP). The same holds true for the term “an inorganic material”. “An inorganic material” means precisely one inorganic material as well as mixtures of two or more inorganic materials. “A metal” means precisely one metal as well as mixtures of two or more metals. A metal within the present invention can be selected from any metal of the periodic table of the elements which is stable under the conditions of a fused filament fabrication process, and which can form three-dimensional objects. Preferably, the metal is selected from the group consisting of aluminium, yttrium, titanium, zirconium, vanadium, niobium, chromium, molybdenum, tungsten, manganese, iron, carbonyl iron powder (CIP), cobalt, nickel, copper, silver, zinc, magnesium, tin and cadmium, more preferably, the metal is selected from the group consisting of titanium, niobium, chromium, molybdenum, tungsten, manganese, iron, carbonyl iron powder (CIP), nickel and copper. With particular preference, the metal is selected from the group consisting of titanium, iron and carbonyl iron powder (CIP).

Carbonyl iron powder (CIP) is highly pure iron powder, prepared by chemical decomposition of purified iron pentacarbonyl.

“A metal alloy” means precisely one metal alloy as well as mixtures of two or more metal alloys. Within the context of the present invention, the term “metal alloy” means a solid solution or a partial solid solution, which exhibits metallic properties and comprises a metal and another element. “A metal” means, as stated above precisely one metal and also mixtures of two or more metals. The same applies to “another element”. “Another element” means precisely one other element and also mixtures of two or more other elements. Solid solution metal alloys exhibit a single solid phase microstructure while partial solid solution metal alloys exhibit two or more solid phases. These two or more solid phases can be homogeneous distributed in the metal alloy, but they can also be heterogeneous distributed in the metal alloy. The metal alloys can be prepared according to any process known to the person skilled in the art. For example, the metal can be melted and the other element can be added to the molten metal. However, it is also possible that the inorganic powder (IP) comprises the metal and the other element without the preparation of a metal alloy before. The metal alloy will then be formed during the process of the preparation of the three-dimensional object.

Concerning the metal, the above-stated embodiments and preferences for the metal apply. The other element can be selected from the metals described above. However, the other element differs from the metal comprised in the metal alloy. The other element can be selected from any element of the periodic table, which forms a metal alloy that is stable under the conditions of a fused filament fabrication process or, which is stable or forms stable alloys with the metal under the conditions of a fused filament process. In a preferred embodiment of the present invention the other element is selected from the group consisting of the aforementioned metals, boron, carbon, silicon, phosphorous, sulfur, selenium and tellurium. Particularly preferably, the at least one other element is selected from the group consisting of the aforementioned metals, boron, carbon, silicon, phosphorous and sulfur. Preferably, the metal alloy according to the present invention comprises steel.

“A ceramic material” means precisely one ceramic material as well as mixtures of two or more ceramic materials. In the context of the present invention, the term “ceramic material” means a non-metallic compound of a metal or a first metalloid, and a non-metal or a second metalloid.

“A metal” means precisely one metal and also mixtures of two or more metals. The same relies to “a non-metal” and “a first metalloid”, as well as “a second metalloid”. “A non-metal” means precisely one non-metal and also mixtures of two or more non-metals. “A first metalloid” means precisely one first metalloid and also mixtures of two or more first metalloids. “A second metalloid” means precisely one second metalloid and also mixtures of two or more second metalloids.

Non-metals are known per se to the person skilled in the art. The non-metal according to the present invention can be selected from any non-metal of the periodic table. Preferably, the at least one non-metal is selected from the group consisting of carbon, nitrogen, oxygen, phosphorus and sulfur.

Metalloids are as well known per se to the skilled person. The first metalloid and the second metalloid can be selected from any metalloid of the periodic table. Preferably, the first metalloid and/or the second metalloid are selected from the group consisting of boron and silicon. It should be clear that the first metalloid and the second metalloid differ from each other. For example, if the first metalloid is boron, then the second metalloid is selected from any other metalloid of the periodic table of the elements besides boron.

In one embodiment of the present invention, the ceramic material is selected from the group consisting of oxides, carbides, borides, nitrides and silicides. In a preferred embodiment the ceramic material is selected from the group consisting of MgO, CaO, SiO₂, Na₂O, Al₂O₃, ZrO₂, Y₂O₃, SiC, Si₃N₄, TiB and AlN. Particularly preferred, the ceramic material is selected from the group consisting of Al₂O₃, ZrO₂ and Y₂O₃.

For the preparation of the inorganic powder (IP), the inorganic material has to be pulverized. To pulverize the inorganic material, any method known to the person skilled in the art can be used. For example, the inorganic material can be ground. The grinding for example can take place in a classifier mill, in a hammer mill or in a ball bill.

The carbonyl iron powder (CIP) is prepared by chemical decomposition of purified iron pentacarbonyl.

The particle sizes of the inorganic powders (IP) used are preferably from 0.1 to 80 μm, particularly preferably from 0.5 to 50 μm, more preferably from 0.1 to 30 μm, measured by laser diffraction.

### Binder (B)

The at least one three-dimensional green body (GB) also comprises a binder (B), wherein the binder (B) preferably comprises
(b1) at least one polyoxymethylene (POM).

In a preferred embodiment, the binder (B) comprises
(b1) from 50 to 96% by weight of at least one polyoxymethylene (POM) based on the total weight of the binder (B),
(b2) from 2 to 35% by weight of at least one polyolefin (PO) based on the total weight of the binder (B),
(b3) from 2 to 40% by weight of at least one further polymer (FP) based on the total weight of the binder (B), where the % by weight of components (b1), (b2) and (b3) generally add up to 100%.

In a more preferred embodiment, the binder (B) comprises
as component (b1) from 60 to 90% by weight of at least one polyoxymethylene (POM),
as component (b2) from 3 to 20% by weight of at least one polyolefin (PO) and
as component (b3) from 5 to 30% by weight of at least one further polymer (FP),
each based on the total weight of the binder (B), where the % by weight of components (b1), (b2) and (b3) usually add up to 100%.

Particularly preferred, the binder (B) comprises
as component (b1) from 70 to 85% by weight of at least one polyoxymethylene (POM),
as component (b2) from 4 to 15% by weight of at least one polyolefin (PO) and
as component (b3) from 10 to 26% by weight of at least one further polymer (FP),
each based on the total weight of the binder (B), where the % by weight of components (b1), (b2) and (b3) add up to 100%.

According to the present invention, component (b1) differs from component (b2), component (b2) differs from component (b3) and component (b3) differs from component (b1). However, component (b1), component (b2) and component (b3) can comprise identical building units and, for example, differ in a further building unit and/or differ in the molecular weight.

The components (b1), (b2) and (b3) of the binder (B) are described in more detail below.

Component (b1)/Polyoxymethylene (POM)

The terms “component (b1)” and “at least one polyoxymethylene (POM)” for the purpose of the present invention are synonymous and are used interchangeably throughout the present invention.

Preferably, the binder (B) comprises 50 to 96% by weight, more preferably 60 to 90% by weight, most preferably 70 to 85% by weight of the at least one polyoxymethylene (POM), based on the total weight of the binder (B).

“At least one polyoxymethylene (POM)” within the present invention means precisely one polyoxymethylene (POM) and also mixtures of two or more polyoxymethylenes (POM). For the purpose of the present invention, the term “polyoxymethylene (POM)” encompasses both, polyoxymethylene (POM) itself, i.e. polyoxymethylene (POM) homopolymers, and also polyoxymethylene (POM) copolymers and polyoxymethylene (POM) terpolymers. Polyoxymethylene (POM) homopolymers usually are prepared by polymerization of a monomer selected from a formaldehyde source (bla). The term “formaldehyde source (bla)” relates to substances which can liberate formaldehyde under the reaction conditions of the preparation of polyoxymethylene (POM). The formaldehyde sources (bla) are advantageously selected from the group of cyclic or linear formals, in particular from the group consisting of formaldehyde and 1,3,5-trioxane. 1,3,5-trioxane is particularly preferred.

Polyoxymethylene (POM) copolymers are known per se and are commercially available. They are usually prepared by polymerization of trioxane as main monomer. In addition, comonomers are concomitantly used. The main monomers are preferably selected from among trioxane and other cyclic or linear formals or other formaldehyde sources (b1a). The expression “main monomers” is intended to indicate that the proportion of these monomers in the total amount of monomers, i.e. the sum of main monomers and comonomers, is greater than the proportion of the comonomers in the total amount of monomers. Quite generally, polyoxymethylene (POM) according to the present invention has at least 50 mol-% of repeating units —CH₂O—in the main polymer chain. Suitable polyoxymethylene (POM) copolymers are in particular those which comprise the repeating units —CH₂O—and from 0.01 to 20 mol-%, in particular from 0.1 to 10 mol-% and very particularly preferably from 0.5 to 6 mol-% of repeating units of the formula (I),

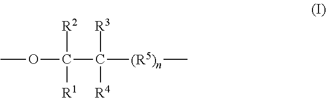

wherein
R¹ to R⁴ are each independently of one another selected from the group consisting of H, C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
wherein
R^{5a} and R^{5b} are each independently of one another selected from the group consisting of H and unsubstituted or at least monosubstituted C₁-C₄-alkyl,
   wherein the substituents are selected from the group consisting of F, Cl, Br, OH and C₁-C₄-alkyl;
n is 0, 1, 2 or 3.

If n is 0, then R⁵ is a chemical bond between the adjacent carbon atom and the oxygen atom. If R⁵ is a (—CR^{5a}R^{5b}O—) group, then the oxygen atom (O) of the (—CR^{5a}R^{5b}O—) group is bound to another carbon atom (C) of formula (I) and not to the oxygen atom (O) of formula (I). In other words, formula (I) does not comprise peroxide compounds. The same holds true for formula (II).

Within the context of the present invention, definitions such as C₁-C₄-alkyl, as for example defined above for the radicals R¹ to R⁴ in formula (I), mean that this substituent (radical) is an alkyl radical with a carbon atom number from 1 to 4. The alkyl radical may be linear or branched and also optionally cyclic. Alkyl radicals which have both a cyclic component and also a linear component likewise fall under this definition. Examples of alkyl radicals are methyl, ethyl, n-propyl, iso-propyl, butyl, iso-butyl, sec-butyl and tert-butyl.

In the context of the present invention, definitions, such as halogen-substituted C₁-C₄-alkyls, as for example defined above for the radicals R¹ to R⁴ in formula (I), mean that the C₁-C₄-alkyl is substituted by at least one halogen. Halogens are F (fluorine), Cl (chlorine), Br (bromine) and I (iodine).

The repeating units of formula (I) can advantageously be introduced into the polyoxymethylene (POM) copolymers by ring-opening of cyclic ethers as first comonomers (b1b). Preference is given to first comonomers (b1b) of the general formula (II),

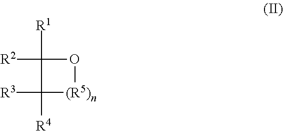

wherein
R¹ to R⁵ and n have the meanings as defined above for the general formula (I).

As first comonomers (b1b) mention may be made for example of ethylene oxide, 1,2-propylene oxide, 1,2-butylene oxide, 1,3-butylene oxide, 1,3-dioxane, 1,3-dioxolane and 1,3-dioxepane (=butanediol formal, BUFO) as cyclic ethers and also linear oligoformals or polyformals such as polydioxolane or polydioxepane. 1,3-dioxolane and 1,3-dioxepane are particularly preferred first comonomers (b1b), very particular preferred is 1,3-dioxepane as first comonomer (b1b).

Polyoxymethylene (POM) polymers which can be obtained by reaction of a formaldehyde source together with the first comonomer (b1b) and a second comonomer (b1c) are likewise suitable. The addition of the second comonomer (b1c) makes it possible to prepare, in particular, polyoxymethylene (POM) terpolymers.

The second comonomer (b1c) is preferably selected from the group consisting of a compound of formula (III) and a compound of formula (IV),

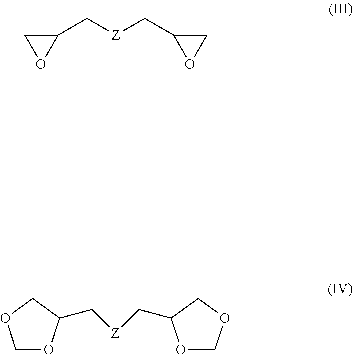

wherein
Z is selected from the group consisting of a chemical bond, an (—O—) group and an (—O—R⁶—O—) group,
wherein
R⁶ is selected from the group consisting of unsubstituted C₁-C₅-alkylene and C₃-C₅-cycloalkylene.

Within the context of the present invention, definitions such as C₁-C₅-alkylene means C₁-C₅-alkanediyle. The C₁-C₅-alkylene is a hydrocarbon having two free valences and a carbon atom number of from 1 to 8. The C₁-C₅-alkylene according to the present invention can be branched or unbranched.

Within the context of the present invention, definitions such as C₃-C₅-cycloalkylene means C₃-C₅-cycloalkanediyle. A C₃-C₅-cycloalkylene is a cyclic hydrocarbon having two free valences and a carbon atom number of from 3 to 8. Hydrocarbons having two free valences, a cyclic and also a linear component, and a carbon atom number of from 3 to 8 likewise fall under this definition.

Preferred examples of the second comonomer (b1c) are ethylene diglycidyl, diglycidyl ether and diethers prepared from glycidyl compounds and formaldehyde, dioxane or trioxane in a molar ratio of 2:1 and likewise diethers prepared from 2 mol of a glycidyl compound and 1 mol of an aliphatic diol having from 2 to 8 carbon atoms, for example the diglycidyl ether of ethylene glycol, 1,4-butanediol, 1,3-butanediol, 1,3-cyclobutanediol, 1,2-propanediol and 1,4-cyclohexanediol.

In a preferred embodiment, component (b1) is a polyoxymethylene (POM) copolymer which is prepared by polymerization of from at least 50 mol-% of a formaldehyde source, from 0.01 to 20 mol-% of at least one first comonomer (b1b) and from 0 to 20 mol-% of at least one second comonomer (b1c).

In a particularly preferred embodiment, component (b1) is a polyoxymethylene (POM) copolymer which is prepared by polymerization of from 80 to 99.98 mol-%, preferably from 88 to 99 mol-% of a formaldehyde source, from 0.1 to 10 mol-%, preferably from 0.5 to 6 mol-% of at least one first comonomer (b1b) and from 0.1 to 10 mol-%, preferably from 0.5 to 6 mol-% of at least one second comonomer (b1c).

In a further preferred embodiment, component (b1) is a polyoxymethylene (POM) copolymer which is prepared by polymerization of from at least 50 mol-% of a formaldehyde source, from 0.01 to 20 mol-% of at least one first comonomer (b1b) of the general formula (II) and from 0 to 20 mol-% of at least one second comonomer (b1c) selected from the group consisting of a compound of formula (III) and a compound of formula (IV).

Another subject of the present invention is therefore a process, wherein component (b1) is a polyoxymethylene (POM) copolymer which is prepared by polymerization of
from at least 50 mol-% of a formaldehyde source (b1a),
from 0.01 to 20 mol-% of at least one first comonomer (b1b) of the general formula (II)

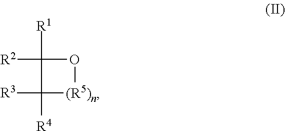

wherein
R¹ to R⁴ are each independently of one another selected from the group consisting of H, C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
wherein
R^{5a} and R^{5b} are each independently of one another selected from the group consisting of H and unsubstituted or at least monosubstituted C₁-C₄-alkyl,
wherein the substituents are selected from the group consisting of F, Cl, Br, OH and C₁-C₄-alkyl;
n is 0, 1, 2 or 3;
and
from 0 to 20 mol-% of at least one second comonomer (b1c) selected from the group consisting of a compound of formula (III) and a compound of formula (IV)

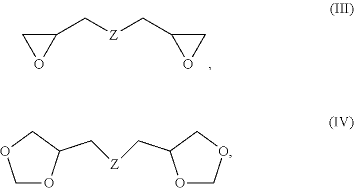

wherein
Z is selected from the group consisting of a chemical bond, an (—O—) group and an (—O—R⁶—O—) group,
wherein
R⁶ is selected from the group consisting of unsubstituted C₁-C₅-alkylene and C₃-C₅-cycloalkylene.

In a preferred embodiment of the present invention, at least some of the OH-end groups of the polyoxymethylene (POM) are capped. Methods for capping OH-end groups are known to the skilled person. For example, the OH-end groups can be capped by etherification or esterification.

Preferred polyoxymethylene (POM) copolymers have melting points of at least 150° C. and weight average molecular weights M_{W} in the range from 5 000 g/mol to 300 000 g/mol, preferably from 6 000 g/mol to 150 000 g/mol, particularly preferably in the range from 7 000 g/mol to 100 000 g/mol.

Particular preference is given to polyoxymethylene (POM) copolymers having a polydispersity (M_{w}/Mₙ) of from 2 to 15, preferably from 2.5 to 12, particularly preferably from 3 to 9.

The measurement of the weight average molecular weight (M_{w}) and the number average molecular weight (Mₙ) is generally carried out by gel permeation chromatography (GPC).

### GPC is Also Known as Sized Exclusion Chromatography (SEC).

Methods for the preparation of polyoxymethylene (POM) are known to those skilled in the art.

Component (b2)/Polyolefin (PO)

Further, the binder (B) may comprise a component (b2).

Preferably, the binder (B) comprises from 2 to 35% by weight, more preferably from 3 to 20% by weight, most preferably from 4 to 15% by weight of component (b2).

Preferably component (b2) is at least one polyolefin (PO). “At least one polyolefin (PO)” within the present invention means precisely one polyolefin (PO) and also mixtures of two or more polyolefins (PO).

Polyolefins (PO) are known per se and are commercially available. They are usually prepared by polymerization of C₂-C₅-alkene monomers, preferably by polymerization of C₂-C₄-alkene monomers.

Within the context of the present invention, C₂-C₅-alkene means unsubstituted or at least monosubstituted hydrocarbons having 2 to 8 carbon atoms and at least one carbon-carbon double bond (C—C-double bond). “At least one carbon-carbon double bond” means precisely one carbon-carbon double bond and also two or more carbon-carbon double bonds.

In other words, C₂-C₈-alkene means that the hydrocarbons having 2 to 8 carbon atoms are unsaturated. The hydrocarbons may be branched or unbranched. Examples for C₂-C₈-alkenes with one C—C-double bond are ethene, propene, 1-butene, 2-butene, 2-methyl-propene (═isobutylene), 1-pentene, 2-pentene, 2-methyl-1-butene, 3-methyl-1-butene, 1-hexene, 2-hexene, 3-hexene and 4-methyl-1-pentene. Examples for C₂-C₈-alkenes having two or more C—C-double bonds are allene, 1,3-butadiene, 1,4-pentadiene, 1,3-pentadiene, 2-methyl-1,3-butadiene (=isoprene).

If the C₂-C₈-alkenes have one C—C-double bond, the polyolefins (PO) prepared from those monomers are linear. If more than one double bond is present in the C₂-C₈-alkenes, the polyolefins (PO) prepared from those monomers can be crosslinked. Linear polyolefins (PO) are preferred.

It is also possible to use polyolefin (PO) copolymers, which are prepared by using different C₂-C₈-alkene monomers during the preparation of the polyolefins (PO).

Preferably, the polyolefins (PO) are selected from the group consisting of polymethylpentene, poly-1-butene, polyisobutylene, polyethylene and polypropylene. Particular preference is given to polyethylene and polypropylene and also their copolymers as are known to those skilled in the art and are commercially available.

The polyolefins (PO) can be prepared by any polymerization process known to the skilled person, preferably by free radical polymerization, for example by emulsion, bead, solution or bulk polymerization. Possible initiators are, depending on the monomers and the type of polymerization, free radical initiators such as peroxy compounds and azo compounds with the amounts of initiator generally being in the range from 0.001 to 0.5% by weight, based on the monomers.

Component (b3)/Further Polymer (FP)

The binder (B) may comprise a further polymer (FP) as component (b3).

The terms “component (b3)” and “further polymer (FP)” for the purpose of the present invention are synonymous and are used interchangeably throughout the present invention.

Preferably, the binder (B) comprises 2 to 40% by weight, more preferably 5 to 30% by weight, most preferably 10 to 26% by weight, based on the total weight of the binder (B), as component (b3).

Component (b3) according to the present invention is at least one further polymer (FP). “At least one further polymer (FP)” within the present invention means precisely one further polymer (FP) and also mixtures of two or more further polymers (FP).

As already stated above, the at least one further polymer (FP) differs from component (b1), the polyoxymethylene (POM), and component (b2), the polyolefin (PO).

According to the present invention, the at least one further polymer (FP) is preferably selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof.

Preferably, component (b3), the at least one further polymer (FP), is selected from the group consisting of a poly(C₂-C₆-alkylene oxide), an aliphatic polyurethane, an aliphatic uncrosslinked epoxide, an aliphatic polyamide, a vinyl aromatic polymer, a poly(vinyl ester) of an aliphatic C₁-C₈ carboxylic acid, a poly(vinyl ether) of a C₁-C₈ alkyl vinyl ether, a poly(alkyl(meth)acrylate) of a C₁₋₈-alkyl and copolymers thereof.

Preferred at least one further polymers (FP) are described in more detail below.

### Polyethers Comprise Repeating Units of Formula (V)

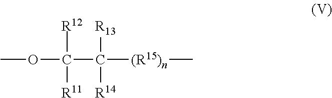

wherein
R¹¹ to R¹⁴ are each independently of one another selected from the group consisting of H, C₁-C₄-alkyl and halogen-substituted C₁-C₄-alkyl;
R¹⁵ is selected from the group consisting of a chemical bond, a (—CR^{15a}R^{15b}—) group and a (—CR^{15a}R^{15b}O—) group,
wherein
R^{15a} and R^{15b} are each independently of one another selected from the group consisting of H and unsubstituted or at least monosubstituted C₁-C₄-alkyl,
   wherein the substituents are selected from the group consisting of F, Cl, Br, OH and C₁-C₄-alkyl;
n is 0, 1, 2 or 3.

If n is 0, then R¹⁵ is a chemical bond between the adjacent carbon atom and the oxygen atom. If R¹⁵ is a (—CR^{15a}R^{15b}O—) group, then the oxygen atom (O) of the (—CR^{15a}R^{15b}O—) group is bound to another carbon atom (C) of formula (V) and not to the oxygen atom (O) of formula (V). In other words, formula (V) does not comprise peroxide compounds.

The same holds true for formula (VI).

Typical polyethers as well as their preparation are known to the skilled person.

A preferred polyether according to the present invention is, for example, a poly(alkylene glycol), also known as a poly(alkylene oxide).

Polyalkylene oxides and their preparation are known to the skilled person. They are usually synthesized by interaction of water and a bi- or polyvalent alcohol with cyclic ethers, i.e. alkylene oxides, of the general formula (VI). The reaction is catalyzed by an acidic or basic catalyst. The reaction is a so-called ring-opening polymerization of the cyclic ether of the general formula (VI)

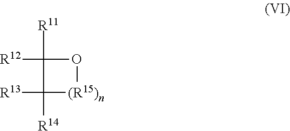

wherein
R¹¹ to R¹⁵ have the same meanings as defined above for formula (V).

A preferred poly(alkylene oxide) according to the present invention is derived from monomers of the general formula (VI) having 2 to 6 carbon atoms in the ring. In other words, preferably, the poly(alkylene oxide) is a poly(C₂-C₆-alkylene oxide). Particular preference is given to a poly(alkylene oxide) derived from monomers selected from the group consisting of 1,3-dioxolane, 1,3-dioxepane and tetrahydrofuran (IUPAC-name: oxolane). In other words, particularly preferably, the poly(alkylene oxide) is selected from the group consisting of poly-1,3-dioxolane, poly-1,3-dioxepane and polytetrahydrofuran.

In one embodiment, the poly(alkylene oxide) can comprise OH-end groups. In another embodiment, at least some of the OH-end groups of the poly(alkylene oxide) can be capped. Methods for capping OH-end groups are known to the skilled person. For example, the OH-end groups can be capped by etherification or esterification.

The weight average molecular weight of the poly(alkylene oxide) is preferably in the range of from 1 000 to 150 000 g/mol, particular preferably from 1 500 to 120 000 g/mol and more preferably in the range of from 2 000 to 100 000 g/mol.

A polyurethane is a polymer having carbamate units. Polyurethanes as well as their preparation is known to the skilled person.

Within the present invention, aliphatic polyurethanes are preferred. They can, for example, be prepared by polyaddition of aliphatic polyisocyanates and aliphatic polyhydroxy compounds. Among the polyisocyanates, diisocyanates of the general formula (VII) are preferred

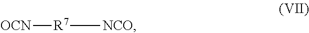

wherein
R⁷ is a substituted or unsubstituted C₁-C₂₀-alkylene or C₄-C₂₀-cycloalkylene, wherein the substituents are selected from the group consisting of F, Cl, Br and C₁-C₆-alkyl.

Preferably R⁷ is a substituted or unsubstituted C₂-C₁₂-alkylene or C₆-C₁₅-cycloalkylene.

Within the context of the present invention, definitions such as C₁-C₂₀-alkylene means C₁-C₂₀-alkanediyle. The C₁-C₂₀-alkylene is a hydrocarbon having two free valences and a carbon atom number of from 1 to 20. The C₁-C₂₀-alkylene according to the present invention can be branched or unbranched.

Within the context of the present invention, definitions such as C₄-C₂₀-cycloalkylene means C₄-C₂₀-cycloalkanediyle. A C₄-C₂₀-cycloalkylene is a cyclic hydrocarbon having two free valences and a carbon atom number of from 4 to 20. Hydrocarbons having two free valences, a cyclic and also a linear component and a carbon atom number of from 4 to 20 likewise fall under this definition.

Preferred diisocyanates are selected from the group consisting of hexamethylenediisocyanate, 2,2,4-trimethyl hexamethylenediisocyanate, 2,4,4-trimethyl hexamethylenediisocyanate, 1,2-diisocyanatomethyl cyclohexane, 1,4-diisocyanatomethyl cyclohexane and isophorondiisocyanate (IUPAC-name: 5-iso-cyanato-1-(isocyanatomethyl)-1,3,3-trimethyl-cyclohexane).

The diisocyanates may also be used in oligomeric, for example dimeric or trimeric form. Instead of the polyisocyanates, it is also possible to use conventional blocked polyisocyanates which are obtained from the stated isocyanates, for example, by an addition reaction of phenol or caprolactam.

Suitable polyhydroxy compounds for the preparation of aliphatic polyurethanes are, for example, polyesters, polyethers, polyesteramides or polyacetales or mixtures thereof.

Suitable chain extenders for the preparation of the polyurethanes are low molecular weight polyols, in particular diols and polyamines, in particular diamines or water.

The polyurethanes are preferably thermoplastic and therefore preferably essentially uncrosslinked, i.e. they can be melted repeatedly without significant signs of decomposition. Their reduced specific viscosities are as a rule from 0.5 to 3 dL/g, preferably from 1 to 2 dL/g measured at 30° C. in dimethylformamide.

A polyepoxide comprises at least two epoxide groups. The epoxide groups are also known as glycidyl or oxirane groups. “At least two epoxide groups” mean precisely two epoxide groups and also three or more epoxide groups.

Polyepoxides and their preparation are known to the person skilled in the art. For example, polyepoxides are prepared by the reaction of epichlorhydrine (IUPAC-name: chlormethyloxirane) and a diol, a polyol or a dicarboxylic acid. Polyepoxides prepared in this way are polyethers having epoxide end groups.

Another possibility to prepare polyepoxides is the reaction of glycidyl(meth)acrylate (IUPAC-name: oxiran-2-ylmethyl-2-methylprop-2-enoate) with polyolefins or polyacrylates. This results in polyolefins or polyacrylates having epoxy end groups.

Preferably, aliphatic uncrosslinkedpolyepoxides are used. Copolymers of epichlorhydrine and 2,2-bis-(4-hydroxyphenyl)-propane (bisphenol A) are particularly preferred.

Component (b3) (the at least one further polymer (FP)) can also comprise a polyamide. Aliphatic polyamides are preferred.

The intrinsic viscosity of suitable polyamides is generally from 150 to 350 mL/g, preferably from 180 to 275 mL/g. Intrinsic viscosity is determined here from a 0.5% by weight solution of the polyamide in 96% by weight sulfuric acid at 25° C. in accordance with ISO 307.

Preferred polyamides are semicrystalline or amorphous polyamides.

Examples of polyamides suitable as component (b3) are those that derive from lactams having from 7 to 13 ring members. Other suitable polyamides are those obtained through reaction of dicarboxylic acids with diamines.

Examples that may be mentioned of polyamides that derive from lactams are polyamides that derive from polycaprolactam, from polycaprylolactam, and/or from polylaurolactam.

If polyamides are used that are obtainable from dicarboxylic acids and diamines, dicarboxylic acids that can be used are alkanedicarboxylic acids having from 6 to 14 carbon atoms, preferably from 6 to 10 carbon atoms. Aromatic dicarboxylic acids are also suitable.

Examples that may be mentioned here as dicarboxylic acids are adipic acid, azelaic acid, sebacic acid, dodecanedicarboxylic acid, and also terephthalic acid and/or isophthalic acid.

Examples of suitable diamines are alkanediamines, having from 4 to 14 carbon atoms, in particular alkanediamines having from 6 to 8 carbon atoms, and also aromatic diamines, for example m-xylylenediamine, di(4-aminophenyl)methane, di(4-aminocyclohexyl)methane, 2,2-di(4-aminophenyl)propane, 2,2-di(4-aminocyclohexyl)-propane, and 1,5-diamino-2-methylpentane.

Other suitable polyamides are those obtainable through copolymerization of two or more of the monomers mentioned above and mentioned below, and mixtures of a plurality of polyamides in any desired mixing ratio.

Preferred polyamides are polyhexamethyleneadipamide, polyhexamethylene-sebacamide, and polycaprolactam, and also nylon-6/6,6, in particular having a proportion of from 75 to 95% by weight of caprolactam units.

Particular preference is given to mixtures of nylon-6 with other polyamides, in particular with nylon-6/6,6 (PA 6/66), particular preference being given to mixtures of from 80 to 50% by weight of PA 6 and from 20 to 50% by weight of PA 6/66, where the PA 6/66 comprises from 75 to 95% by weight of caprolactam units, based on the total weight of the PA 6/66 in the mixture.

The following, non-exclusive list comprises the abovementioned polyamides, and other suitable polyamides, and also the monomers comprised.

AB polymers:
PA 4 Pyrrolidone
PA 6 E-Caprolactam
PA 7 Ethanolactam
PA 8 Caprylolactam
PA 9 9-Aminopelargonic acid
PA 11 11-Aminoundecanoic acid
PA 12 Laurolactam
   AA/BB polymers:
PA 46 Tetramethylenediamine, adipic acid
PA 66 Hexamethylenediamine, adipic acid
PA 69 Hexamethlyenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA MXD6 m-Xylylenediamine, adipic acid
PA 61 Hexamethylenediamine, isophthalic acid
PA 6-3-T Trimethylhexamethylenediamine, terephthalic acid
PA 6/6T (see PA 6 and PA 6T)
PA 6/66 (see PA 6 and PA 66)
PA 6/12 (see PA 6 and PA 12)
PA 66/6/610 (see PA 66, PA 6 and PA 610)
PA 61/6T (see PA 61 and PA 6T)
PA PACM 6 Diaminodicyclohexylmethane, adipic acid
PA PACM 12 Diaminodicyclohexylmethane, laurolactam
PA 61/6T/PACM as PA 61/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Preferred polyamides are PA 6, PA 66 and PA PACM 6.

Vinyl aromatic polymers are polyolefins having unsubstituted or at least monosubstituted styrene as monomer unit. Suitable substituents are, for example, C₁-C₆-alkyls, F, Cl, Br and OH. Preferred vinyl aromatic polymers are selected from the group consisting of polystyrene, poly-α-methylstyrene and copolymers thereof with up to 30% by weight of comonomers selected from the group consisting of acrylic esters, acrylonitrile and methacrylonitrile.

Vinyl aromatic polymers are commercially available and known to the person skilled in the art. The preparation of these polymers is also known to the person skilled in the art.

Preferably, the vinyl aromatic polymers are prepared by free radical polymerization, for example, by emulsion, bead, solution or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(vinyl esters) and their preparation are known to the skilled person. Poly(vinyl esters) are preferably prepared by polymerization of vinyl esters. In a preferred embodiment of the present invention, the vinyl esters are vinyl esters of aliphatic C₁-C₈ carboxylic acids. Preferred monomers are vinyl acetate and vinyl propionate. These monomers form poly(vinyl acetate) and poly(vinyl propionate) polymers.

Poly(vinyl ethers) are prepared by polymerization of vinyl ether monomers. Poly(vinyl ethers) and their preparation are known to the skilled person. In a preferred embodiment, the vinyl ethers are vinyl ethers of aliphatic C₁-C₈ alkyl ethers. Preferred monomers are methyl vinyl ether and ethyl vinyl ether, forming poly(methyl vinyl ether) and poly(ethyl vinyl ether) during the polymerization.

Preferably, the poly(vinyl ethers) are prepared by free radical polymerization, for example, by emulsion, bead, solution, suspension or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(alkyl(meth)acrylate) within the present invention comprises poly(alkyl acrylate), poly(alkyl methacrylates) and copolymers thereof. Poly(alkyl(meth)acrylate) comprises units derived from monomers of formula (VIII),

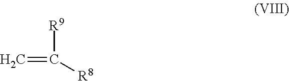

wherein
R⁸ is selected from the group consisting of H and C₁-C₈-alkyl and
R⁹ is a radical of formula (IX)

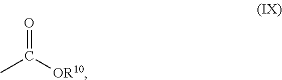

wherein
R¹⁰ is a C₁-C₁₄-alkyl.

Preferably, R⁸ is selected from the group consisting of H and C₁-C₄-alkyl, particularly preferably R⁸ is H or methyl. Preferably, R¹⁰ is a C₁-C₅-alkyl, particularly preferably, R¹⁰ is methyl or ethyl.

If R⁸ in formula (VIII) is H and R⁹ is a radical of formula (IX) and R¹⁰ in formula (IX) is methyl, then the monomer of formula (VIII) is methyl acrylate.

If R⁸ in formula (VIII) is H and R⁹ is a radical of formula (IX) and R¹⁰ in formula (IX) is ethyl, the monomer of formula (VIII) is ethyl acrylate.

If R⁸ in formula (VIII) is methyl and R⁹ is a radical of formula (IX), then the monomers of formula (VI) are methacrylic esters.

Poly(alkyl(meth)acrylates) comprise as monomers preferably 40 to 100% by weight of methacrylic esters, particularly preferably 70 to 100% by weight of methacrylic esters and more preferably from 80 to 100% by weight of methacrylic esters, each based on the total amount of the poly(alkyl(meth)acrylates).

In another preferred embodiment, the poly(alkyl(meth)acrylates) comprise as monomers from 20 to 100% by weight of methyl acrylate, ethyl acrylate or a mixture thereof, preferably from 40 to 100% by weight of methyl acrylate, ethyl acrylate or a mixture thereof and particularly preferably from 50 to 100% by weight of methyl acrylate, ethyl acrylate or mixtures of thereof, each based on the total weight of the poly(alkyl(meth)acrylate).

Such polymers of monomers of the formula (VIII) with or without further monomers can be prepared in a conventional, preferably a free radical polymerization, for example an emulsion, bead, solution or bulk polymerization (cf. Kirk-Othmer, Encyclopedia of Chemical Technology 3^{rd} Ed., Vol. 1., pp. 330-342, Vol. 18, pp. 720-755, J. Wiley; H.

Rauch-Puntigam, Th. Volker, Acryl- und Methacrylverbindungen). Possible initiators depending on the monomers and the type of polymerization are free radical initiators, such as peroxy or peroxo compounds and azo compounds. The amount of initiator being in general within the range from 0.001 to 0.5% by weight, based on the monomers.

Suitable initiators for an emulsion polymerization are, for example, peroxodisulfates and redox systems for a bulk polymerization not only peroxides, such as dibenzoyl peroxide or dilauroyl peroxide, but also azo compounds, for example azobisisobutyrodinitrile, similarly in the case of the solution or bead polymerization. The molecular weight may be regulated using conventional regulators, in particular mercaptans, e.g. dodecylmercaptan.

Preferably, the polymerization is carried out at elevated temperatures, for example above 50° C. The weight average molecular weight (M_{W}) is in general within the range of from 2 000 to 5 000 000 g/mol, preferably from 20 000 to 3 000 000 g/mol (determination by light scattering; cf. HoubenWeyl, Methoden der Org. Chemie, 4^{th} edition, Volume 14/1, Georg Thieme-Verlag Stuttgart 1961).

The person skilled in the art knows that the monomers described above for the preparation of the components (b1), (b2) and (b3) can undergo changes in their structure during the polymerization reaction. Consequently, the building units of the polymers are not the same as the monomers from which they are derived. However, the person skilled in the art knows which monomers correspond to which building unit of the polymers.

Under the conditions of compounding or processing by injection molding or fused filament fabrication, virtually no transacetalization occurs between component (b1), the polyoxymethylene (POM), and component (b3), the at least one further polymer (FP), i.e. virtually no exchange of comonomer units takes place.

### Three-Dimensional Green Body

The at least one three-dimensional green body (GB) can be prepared by any method known to the skilled person, for example, by an additive manufacturing process such as a fused filament fabrication process or by injection moulding. Preferably, the at least one three-dimensional green body (GB) is prepared by a fused filament fabrication process.

The fused filament fabrication process for the production of the at least one three-dimensional green body (GB) is well known in the state of the art. The fused filament fabrication process is also denominated as 3D-printing process. The filaments can comprise continuous filaments and rods, pellets and/or powders.

Preferably, the fused filament fabrication process comprises the steps
i) providing a mixture (M) to a nozzle, wherein the mixture (M) comprises an inorganic powder (IP) and a binder (B), wherein the binder (B) preferably comprises at least one polyoxymethylene (POM),
ii) heating the mixture (M) to a temperature (T_{M}),
iii) depositing the mixture (M) into a build chamber using a layer-based additive technique to form the at least one three-dimensional green body (GB).

The above-mentioned embodiments and preferences in respect of the at least one three-dimensional green body (GB) comprising an inorganic powder (IP) and a binder (B), wherein the binder (B) preferably comprises at least one polyoxymethylene (POM), apply analogously to the mixture (M).

The mixture (M) can be prepared by any method known to the skilled person. Preferably the mixture (M) is produced by melting the binder (B) and mixing in the inorganic powder (IP) and, if appropriate, the at least one dispersant. For example, the binder (B) can be melted in a twin-screw extruder at temperatures of preferably from 150 to 220° C., in particular of from 170 to 200° C. The inorganic powder (IP) is subsequently metered in the required amount into the melt stream of the binder (B) at temperatures in the same range. The inorganic powder (IP) advantageously comprises the at least one dispersant on the surface. However, the mixture (M) of the invention can also be produced by melting the binder (B) and optionally the at least one dispersant in the presence of the inorganic powder (IP) at temperatures of from 150 to 220° C., preferably of from 170 to 200° C.

A particularly preferred apparatus for metering the inorganic powder (IP) comprises as essential element a transport screw which is located in a heatable metal cylinder and transports the inorganic powder (IP) into the melt of the binder (B). The above-described process has the advantage over mixing of the components at room temperature and subsequent extrusion with an increase in temperature that decomposition of polyoxymethylene (POM) used as binder as a result of the high shear forces occurring in this variant is largely avoided.

### Step b)

In step b), an acid is provided.

Suitable acids are, for example, inorganic acids which are either gaseous at room temperature or can be vaporized at the temperatures of step c) or below. Examples are hydrogen halides and nitric acid. Hydrogen halides are hydrogen fluoride, hydrogen chloride, hydrogen bromide and hydrogen iodide. Suitable organic acids are those, which have a boiling point at atmosphere pressure of less than 130° C., e. g. formic acid, acetic acid or trifluoroacetic acid and mixtures thereof. Acids with boiling points above 130° C., for example methanesulfonic acid, can also be utilized when dosed as a mixture with a lower boiling acid and/or water. Preferred acids are, for example, nitric acid, a 10% by weight solution of oxalic acid in water or a mixture of 50% by volume of methanesulforic acid in water.

Furthermore, BF₃ and its adducts with inorganic ethers can be used as acids.

If a carrier gas is used, the carrier gas is generally passed through the acid and loaded with the acid beforehand. The carrier gas, which has been loaded in this way with the acid, is then brought to the temperature at which process step c) is carried out. This temperature is advantageously higher than the loading temperature in order to avoid condensation of the acids.

Preferably the temperature at which process step c) is carried out is at least 1° C., particularly preferably at least 5° C. and most preferably at least 10° C. higher than the loading temperature.

Preference is given to mixing the acid into the carrier gas by means of a metering device and heating the gas mixture to such a temperature that the acid can no longer condense.

Preferably the temperature is at least 1° C., particularly preferably at least 5° C. and most preferably at least 10° C. higher than the sublimation and/or vaporization temperature of the acid and/or the carrier gas.

The carrier gas in general is any gas that is inert under the reaction conditions of the debinding step. A preferred carrier gas according to the present invention is nitrogen.

In an especially preferred embodiment, in step b), 0.01 to 5.0% by weight, more preferably 0.05 to 2.5% by weight, and most preferably 0.1 to 1.5% by weight, of anhydrous oxalic acid, based on the total weight of the at least one three-dimensional green body (GB), are provided.

The anhydrous oxalic acid has preferably a purity of 95%, more preferably of 98%.

Therefore, the anhydrous oxalic acid preferably comprises at most 5% by weight, more preferably at most 2% by weight, most preferably at most 1% by weight, and particularly preferably, 0% by weight, of water, based on the total weight of the anhydrous oxalic acid.

### Step c)

In step c), the at least one three-dimensional green body (GB) is treated with the acid in the tube furnace in order to obtain at least one three-dimensional brown body (BB).

By performing step c), preferably part of the binder (B) is removed. Preferably, in step c), the binder (B) is removed to an extend of at least 90% by weight, more preferably of at least 95% by weight, based on the total weight of the binder (B) comprised in the at least one three-dimensional green body (GB) provided in step a). This can be checked, for example, with the height of the weight decrease.

After the removal of the binder (B) in step c), the resulting three-dimensional object is called a “three-dimensional brown body”. The three-dimensional brown body (BB) comprises the inorganic powder (IP) and the fraction of the binder (B), which was not removed during the debinding. The person skilled in the art knows that a three-dimensional brown body comprising a ceramic material as inorganic powder (IP) is also called a three-dimensional white body. However, forth purpose of the present invention, the terms “three-dimensional brown body” and “three-dimensional white body” are used synonymous and are interchangeable.

In a preferred embodiment, the at least one three-dimensional brown-body (BB) formed in step c) comprises from 90 to 100% by volume of the inorganic powder (IP) and from 0 to 10% by volume of the binder (B), preferably from 95 to 100% by volume of the inorganic powder (IP) and from 0 to 5% by volume of the binder (B), based on the total volume of the at least one three-dimensional brown-body (BB).

It is known to the skilled person that at the temperatures during step c), the inorganic powder (IP) comprised in the at least one three-dimensional green body (GB) can undergo chemical and/or physical reactions. In particular, the particles of the inorganic powder (IP) can fuse together, and the inorganic powder can undergo solid state phase transitions.

The same holds true for the binder (B). During the step c) the composition of the binder (B) can change.

Consequently, in one embodiment of the present invention, the inorganic powder (IP) and/or the binder (B) comprised in the at least one three-dimensional green body (GB) differs from the inorganic powder (IP) and/or the binder (B) comprised in the three-dimensional brown body (BB) obtained in process step c).

The debinding step prior the sintering process is important to extract a fraction of the binder matrix. There are different possibilities to perform that e.g., thermally, dissolving with solvent or chemically. A sort of the chemical debinding process is the so called catalytic debinding process where the binder polymers are decomposed by the usage of a gaseous acid.

In an especially preferred embodiment, in step c), the at least one three-dimensional green body (GB) is treated with an anhydrous oxalic acid at a temperature (T1)<140° C. in the presence of an inert gas.

In this case, preferably, in step c), the at least one three-dimensional green body (GB) is treated with the anhydrous oxalic acid at a temperature (T1) of from 110 to 135° C., more preferably at a temperature (T1) of from 110 to 130° C.

The inert gas can be any gas that is substantially free of oxygen and water. It is preferably selected from the group consisting of hydrogen, nitrogen, and a noble gas, more preferably from nitrogen and argon.

Step c) is carried out in the inventive tube furnace.

In a preferred embodiment, the anhydrous oxalic acid as well as the at least one three-dimensional green body (GB) is placed in the inventive tube furnace. The inventive tube furnace is preferably heated to a temperature (T1)<140° C., which is lower than the sublimation temperature of the anhydrous oxalic acid, more preferably to a temperature (T1) of from 110 to 135° C., most preferably to a temperature (T1) of from 110 to 130° C.

### Step d)

Optionally, an additional step d) may be carried out.

Preferably, step c) is followed by a step d), in which the at least one three-dimensional brown body (BB) is sintered to form at least one three-dimensional sintered body (SB). Process step d) is also called sintering. The terms “process step d)” and “sintering” for the purpose of the present invention are synonymous and are used interchangeably throughout the present invention.

After the sintering, the three-dimensional object is a three-dimensional sintered body (SB). The three-dimensional sintered body (SB) comprises the inorganic powder (IP) and is essentially free of the binder (B).

“Essentially free of the binder (B)” according to the present invention means that the three-dimensional sintered body (SB) comprises less than 5% by volume, preferably less than 2% by volume, particularly preferably less than 0.5% by volume and most preferably less than 0.01% by volume of the binder (B), based on the total volume of the three-dimensional sintered body (SB).

It is known to the skilled person that during the sintering process the inorganic powder (IP) is sintered together to give a sintered inorganic powder. Furthermore, during the sintering process the inorganic powder (IP) can undergo chemical and/or physical reactions. Consequently, the inorganic powder (IP) comprised in the three-dimensional brown body (BB) usually differs from the sintered inorganic powder comprised in the three-dimensional sintered body (SB).

In one embodiment of the present invention, after process step c) and before process step d), the three-dimensional brown body (BB) obtained in process step c) is heated for preferably 0.1 to 12 h, particularly preferably from 0.3 to 6 h, at a temperature of preferably from 250 to 700° C., particularly preferably from 250 to 600° C. to remove the residual binder (B) completely.

The temperature as well as the duration and the atmosphere during process step d) depend on the inorganic powder (IP) comprised in the mixture (M). The temperature programme of the sintering process, the duration and the atmosphere is in general adapted to the needs of the inorganic powder (IP) comprised in the mixture (M). Suitable conditions for process step d) are known to the skilled person.

In general, process step d) is carried out under the atmosphere of a gas that is inert regarding the inorganic powder (IP) and the binder (B). Typical inert gases are for example nitrogen and/or argon.

Depending on the inorganic powder (IP) comprised in the mixture (M), it is also possible to carry out process step d) in air, under vacuum or in hydrogen atmosphere.

The temperature (T2) in process step d) is in general, for example, in the range of from 750 to 1600° C., preferably of from 800 to 1500° C. and particularly preferably of from 850 to 1450° C.

Step d) is carried out in an inventive tube furnace, wherein the tube furnace is preferably the same tube furnace in which step c) is carried out.

1.-15. (canceled)

16. A method comprising carrying out a sintering and/or debinding process in a tube furnace, wherein the tube furnace comprises a tube (T) comprising an oxide ceramic matrix composite (OCMC).

17. The method as claimed in claim 16, wherein the tube (T) comprises an inner tube (IT) and an outer layer (OL), wherein the outer layer (OL) is attached to the inner tube (IT) and wherein the inner tube (IT) comprises a non-porous monolithic oxide ceramic and the outer layer (OL) comprises the oxide ceramic matrix composite (OCMC).

18. The method as claimed in claim 16, wherein the tube (T) comprises two ends, wherein the tube (T) is closed on both ends, open on both ends or closed on one end and open on the other end.

19. The method as claimed in claim 17, wherein the inner diameter of the inner tube (IT) is in the range from 50 mm to 500 mm.

20. The method as claimed in claim 16, wherein the tube (T) is heated over a length from 100 mm to 1000 mm.

21. The method as claimed in claim 16, wherein the tube (T) is heated to a temperature in the range from 1250° C. to 1500° C.

22. The method as claimed in claim 16, wherein the oxide ceramic matrix composite (OCMC) comprises
a matrix (M), wherein the matrix (M) comprises oxidic ceramic particles (P), and
fibres (F),
wherein the fibres (F) are embedded as a linear, sheet-like, or three-dimensional textile structure between the oxidic ceramic particles (P) of the matrix (M).

23. The method as claimed in claim 22, wherein the oxidic ceramic particles (P) are particles comprising oxides of at least one element selected from the group consisting of Be, Mg, Ca, Sr, Ba, rare earths, Th, U, Ti, Zr, Hf, V, Nb, Ta, Cr, Mo, W, Mn, Fe, Co, Ni, Zn, B, Al, Ga, Si, Ge, Sn, Li, Na, K, Rb, Cs, Re, Ru, Os, Ir, Pt, Rh, Pd, Cu, Ag, Au, Cd, In, TI, Pb, P, As, Sb, Bi, S, Se and Te, or mixtures of these oxides.

24. The method as claimed in claim 22, wherein the fibres (F) are ceramic fibres (F).

25. The method as claimed in claim 22, wherein the fibres (F) have a diameter in the range from 5 to 15 μm.

26. The method as claimed in claim 16, wherein the tube furnace comprises heating elements outside the tube (T).

27. The method as claimed in claim 26, wherein the non-porous monolithic oxide ceramic comprises at least 97% by weight of at least one compound selected from the group consisting of aluminum oxide (Al₂O₃) and mullite, based on the total weight of the non-porous monolithic oxide ceramic.

28. The method as claimed in claim 17, wherein the tube (T) is prepared by a process comprising at least the following steps i) and ii)
i) providing the inner tube (IT) comprising the non-porous monolithic oxide ceramic, and
ii) attaching the outer layer (OL) to the inner tube (IT), preferably by a laminating technique.

29. A method comprising carrying out a sintering and/or debinding process in a process for treatment of at least one three-dimensional green body (GB) in a tube furnace, wherein the tube furnace comprises a tube (T) comprising an oxide ceramic matrix composite (OCMC), and wherein the process comprises:
a) providing the at least one three-dimensional green body (GB), wherein the at least one three-dimensional green body (GB) comprises an inorganic powder (IP) and a binder (B),
b) providing an acid,
c) treating the at least one three-dimensional green body (GB) with the acid in the tube furnace in order to obtain at least one three-dimensional brown body (BB), and optionally
d) sintering the at least one three-dimensional brown body (BB) obtained in step c) in the tube furnace in order to obtain at least one three-dimensional sintered body (SB).
